(19) United States
(12) Patent Application Publication
(10) Pub. No.: US 2020/0092435 A1
(43) Pub. Date: Mar. 19, 2020

(54) IMAGE PROCESSING APPARATUS AND INFORMATION PROCESSING METHOD

(71) Applicant: CANON KABUSHIKI KAISHA, Tokyo (JP)

(72) Inventor: Tsunahito Nakashita, Abiko-shi (JP)

(21) Appl. No.: 16/565,171

(22) Filed: Sep. 9, 2019

(30) Foreign Application Priority Data
Sep. 18, 2018 (JP) 2018-173838

(51) Int. Cl. H04N 1/00; G06F 13/16; G06F 13/42

(52) U.S. Cl. CPC H04N 1/00925; H04N 1/00891; H04N 1/00029; G06F 2213/0042; H04N 1/00082; G06F 13/1668; G06F 13/4282; H04N 1/00074

(57) ABSTRACT

An image processing apparatus includes a storage device, and a control unit that, in a case where the storage device is a hard disk drive and the image processing apparatus is in an idling state, cancels a logical connection state of the storage device and blocks access to the storage device.

### BACKGROUND

### Field

The present disclosure relates to an image processing apparatus and an information processing method.

### Description of the Related Art

Conventionally, a large-capacity storage device such as a hard disk drive (HDD) or a solid state disk (SSD) is installed in an image forming apparatus, and achieves a storage function for storing an operation program, and saving and editing image data. In order to enhance functionality of an image forming apparatus, application programs are installed for various functions.

The HDD includes a disk as a magnetic recording medium and a head for reading and writing data. While moving through gaps between the disks which rotate at a high speed, the head accesses to the disk (loading), and thus data can be read and written randomly at a high speed. Impact applied to the HDD during the loading might damage the head and the disk of the HDD, and thus a dominant configuration of the HDD is that the head is retracted to a home position after the loading. A loading and unloading count of the head is specified as a service life for each HDD.

As for the service life of each HDD, a power-on count and an operation time of a spindle motor are also specified.

Regarding the service life of the HDD, in some cases, the power-on count is controlled so that a product lifetime of an image forming apparatus mounted with such an HDD is guaranteed (Japanese Patent Application Laid-Open No. 2005-186426).

A rewriting count is specified as a service life of the SSD, and the specified value has become smaller as a result of manufacturing processing of a flash memory to be installed in the SSD becoming finer.

### SUMMARY

According to an aspect of the present disclosure, an image processing apparatus includes a storage device, and a control unit that, in a case where the storage device is a hard disk drive and the image processing apparatus is in an idling state, cancels a logical connection state of the storage device and blocks access to the storage device.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of a controller unit of an image forming apparatus.

FIG. 2 is a diagram illustrating an example of an internal configuration of a hard disk drive (HDD).

FIG. 3 is a diagram illustrating an example of an internal configuration of a solid state disk (SSD).

FIG. 4 is a diagram describing processing according to a first exemplary embodiment.

FIG. 5 is a flowchart illustrating an example of information processing according to the first exemplary embodiment.

FIG. 6 is a diagram describing processing according to a second exemplary embodiment.

FIG. 7 is a flowchart illustrating an example of information processing according to the second exemplary embodiment.

FIGS. 8A and 8B (collectively FIG. 8) are flowcharts illustrating an example of information processing according to a third exemplary embodiment.

FIGS. 9A and 9B (collectively FIG. 9) are flowcharts illustrating an example additionally including erroneous access mask processing.

FIG. 10 is a flowchart illustrating an example additionally including the erroneous access mask processing.

FIGS. 11A and 11B (collectively FIG. 11) are flowcharts illustrating an example additionally including the erroneous access mask processing.

FIG. 12 is a flowchart illustrating an example additionally including the erroneous access mask processing.

FIG. 13 is a flowchart illustrating an example of information processing according to a fifth exemplary embodiment.

FIG. 14 is a flowchart illustrating an example of information processing according to a sixth exemplary embodiment.

### DESCRIPTION OF THE EMBODIMENTS

Exemplary embodiments of the present disclosure will be described below with reference to the drawings.

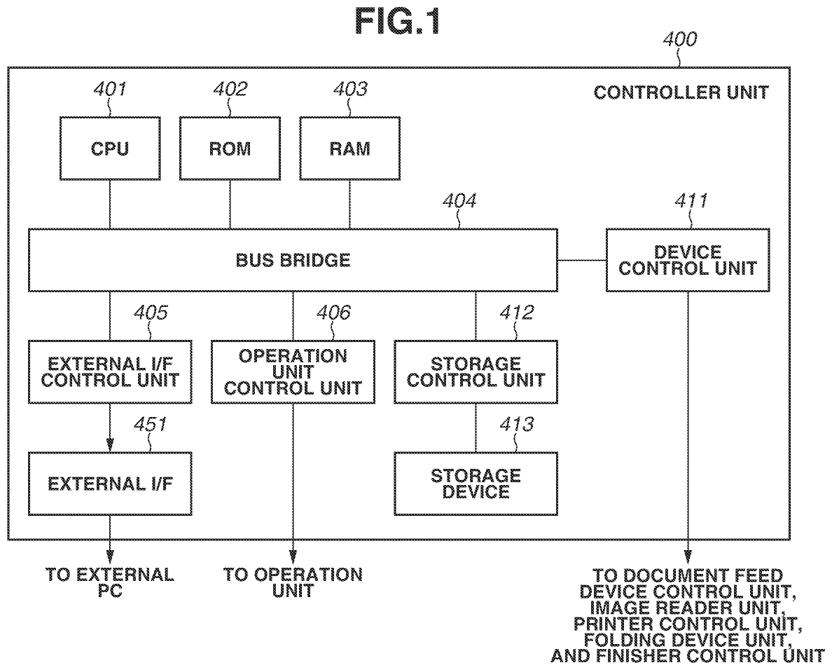

FIG. 1 is a diagram illustrating an example of a hardware configuration of a controller unit 400 of an image forming apparatus which incorporates a storage device 413 such as a hard disk drive (HDD) or a solid state disk (SSD). The image forming apparatus is an example of an image processing apparatus.

The controller unit 400 communicates with a document feed device control unit that controls a document feed device and an image reader control unit that controls an image reader, based on an instruction from an operation unit or an external computer, and acquires image data of an input document. The controller unit 400 further communicates with a printer control unit that controls a print unit and prints the image data on a sheet. The controller unit 400 further communicates with a folding device control unit that controls a folding device and with a finisher control unit that controls a finisher so as to achieve a desired output using staples or punching holes for a printed sheet.

An external interface (I/F) 451 is an interface that connects with an external computer. For example, the external I/F 451 is connected with the external computer via a network or an external bus such as a universal serial bus (USB), and develops print data from the external computer into an image so as to output the image. Further, the external I/F 451 transmits image data in a storage device 413, described later, to the external computer.

The controller unit 400 includes a central processing unit (CPU) 401, and is controlled by an operating system (OS) 10. The CPU 401 is connected to a bus bridge 404, and reads out an initial activation program from a read only memory (ROM) 402, which stores the initial activation program of the CPU 401, via the bus bridge 404. A random access memory (RAM) 403, which is used as a work area where a calculation associated with control is made, and a storage control unit 412, which controls a storage device, are also connected with the bus bridge 404.

The storage device 413 is used to store main programs including the OS 10 of the CPU 401, to save image data acquired by the image reader or the external I/F 451 or an image edited by the operation unit. The storage device 413 is used also to store application programs and user preference data. The storage device 413 is configured to be accessed by the CPU 401.

The HDD or the SSD is used as the storage device 413.

An external I/F control unit 405 that controls a network and a USB interface, and an operation unit control unit 406 that controls the operation unit are connected to the bus bridge 404.

A device control unit 411 is connected with the document feed device control unit, the image reader control unit, the printer control unit, the folding device control unit, and the finisher control unit so as to control them.

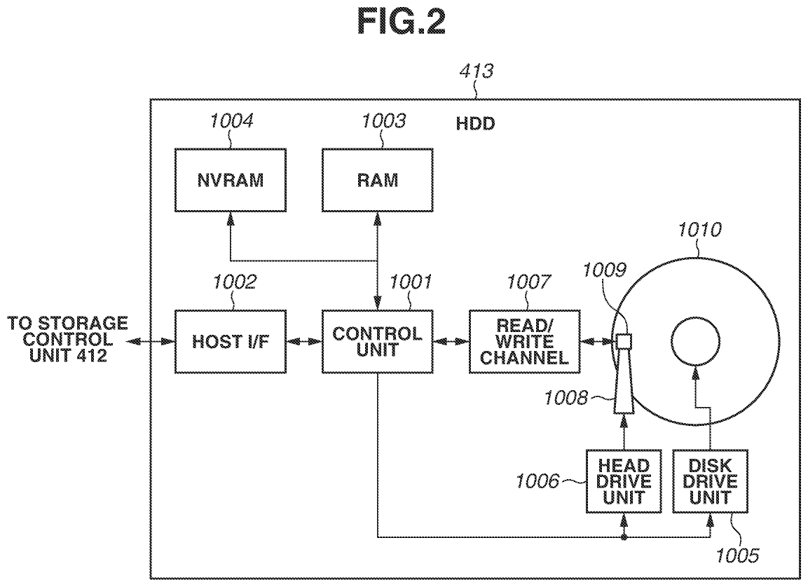

FIG. 2 is a diagram illustrating an example of an internal configuration of the HDD.

The HDD includes a control unit 1001, a host I/F 1002, a RAM 1003, a non-volatile random access memory (NVRAM) 1004, a disk drive unit 1005, a head drive unit 1006, a read/write signal processing unit 1007, an arm 1008, a magnetic head 1009, and a magnetic disk 1010.

The host I/F 1002 is a module for communication with the storage control unit 412. In the example of FIG. 2, a Serial AT Attachment (hereinafter, SATA) interface is used as the host I/F 1002.

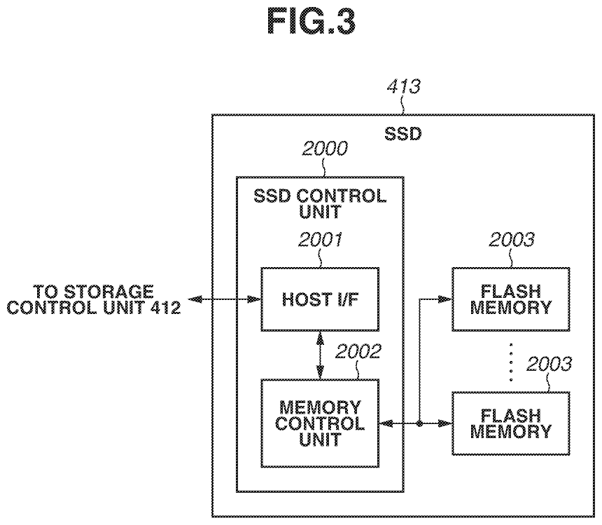

FIG. 3 is a diagram illustrating an example of an internal configuration of the SSD.

In FIG. 3, the SSD includes an SSD control unit 2000 and a plurality of flash memories 2003. The SSD control unit 2000 includes the host I/F 1002 and a memory control unit 2002. Like the HDD, the host I/F 1002 is connected to the storage control unit 412.

Normally, an easy and general way to restrict access to the storage device 413 is to turn off the power of the storage device 413. However, in a case where the storage device 413 is the HDD, a power-on count (the number of times power-off and power-on is performed) is limited. For this reason, the access restriction cannot be handled only by the power-off, and thus is achieved by a method described below.

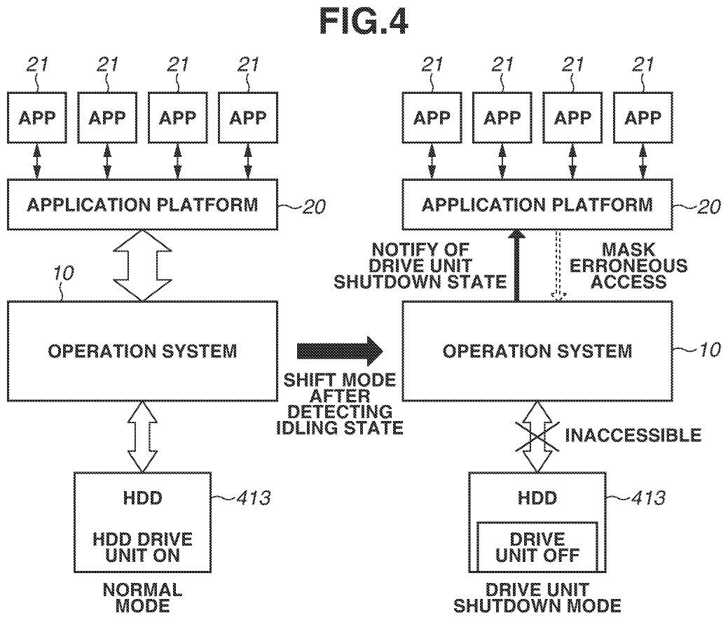

FIG. 4 is a diagram describing processing according to the first exemplary embodiment.

Application programs (hereinafter, apps) 21 to be installed into the image forming apparatus run on the OS 10 via an application platform 20 as illustrated in FIG. 4. Accordingly, in a case where the apps 21 access the storage device 413, the apps 21 access a file system of the OS 10 via the application platform 20.

In a case where the CPU 401 detects that the storage device 413 installed in the present exemplary embodiment is the HDD and that the image forming apparatus is in an idling state, the CPU 401 shuts down a spindle motor so as to block the accesses from the apps 21.

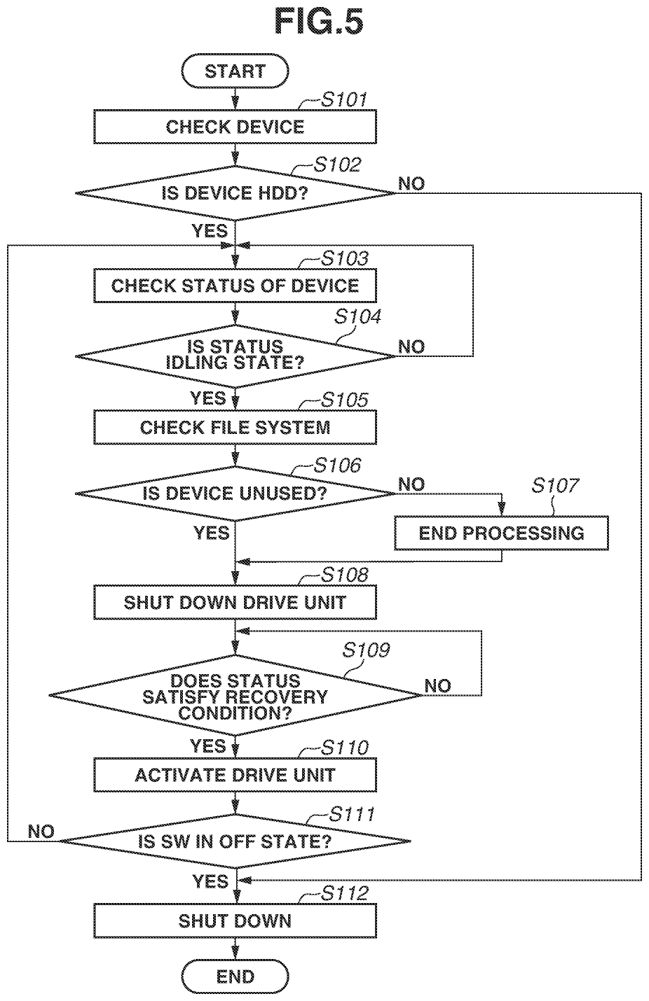

FIG. 5 is a flowchart illustrating an example of information processing according to the first exemplary embodiment. The processing illustrated in FIG. 5 is achieved by the CPU 401 by executing the processing based on the OS 10.

In step S101, the CPU 401 acquires Self-Monitoring, Analysis and Reporting Technology (S.M.A.R.T.) information (diagnostic information) about the storage device 413, and identifies a type of the storage device 413.

In step S102, if the CPU 401 determines that the storage device 413 is the HDD, based on the diagnostic information (Yes in step S102), the processing proceeds to step S103, and if the CPU 301 determines that the storage device 413 is not the HDD (No in step S102), the processing proceeds to step S112.

In step S103, the CPU 401 checks a status of the image forming apparatus.

In step S104, if the status checked in step S103 is the idling state where no job runs and no operation is performed by a user (Yes in step S104), the processing proceeds to step S105, and if not (No in step S104), the processing returns to step S103.

In step S105, the CPU 401 checks the file system of the OS 10, and in step S106, checks a use state of the storage device 413. If the CPU 401 determines that the storage device 413 is unused (Yes in step S106), the processing proceeds to step S108, and if not (No in step S106), the processing proceeds to step S107.

In step S107, the CPU 401 identifies processing which uses the device from the file system, ends the identified processing to cancel the use state.

In step S108, the CPU 401 sends a spindle motor shutdown command to the HDD via the storage control unit 412. The HDD, which has received the shutdown command, causes the control unit 1001 to shut down the disk drive unit 1005.

In step S109, the CPU 401 determines whether the status satisfies a condition for recovery to the normal operation state, such as a job being input and an operation being performed by a user. If the CPU 401 determines that the status satisfies the recovery condition (Yes in step S109), the processing proceeds to step S110. If not (No in step S109), the CPU 401 repeats the processing in step S109.

In step S110, the CPU 401 sends a spindle motor activation command to the HDD via the storage control unit 412. The HDD, which has received the activation command, causes the control unit 1001 to activate the disk drive unit 1005.

In step S111, the CPU 401 checks a power switch of the image forming apparatus. If the CPU 401 determines that the switch is in an off state (Yes in step S111), the processing proceeds to step S112. If not (No in step S111), the processing returns to step S103.

In step S112, the CPU 401 executes shutdown processing.

In the processing according to the present exemplary embodiment, the shutdown of the spindle motor of the HDD can block unnecessary access from apps 21 without increasing the power-on count, and thus the loading and unloading count can be repressed.

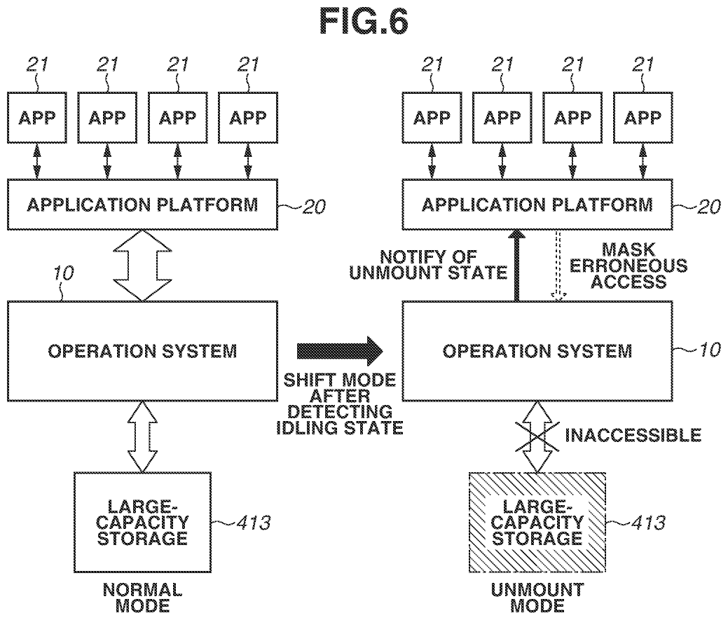

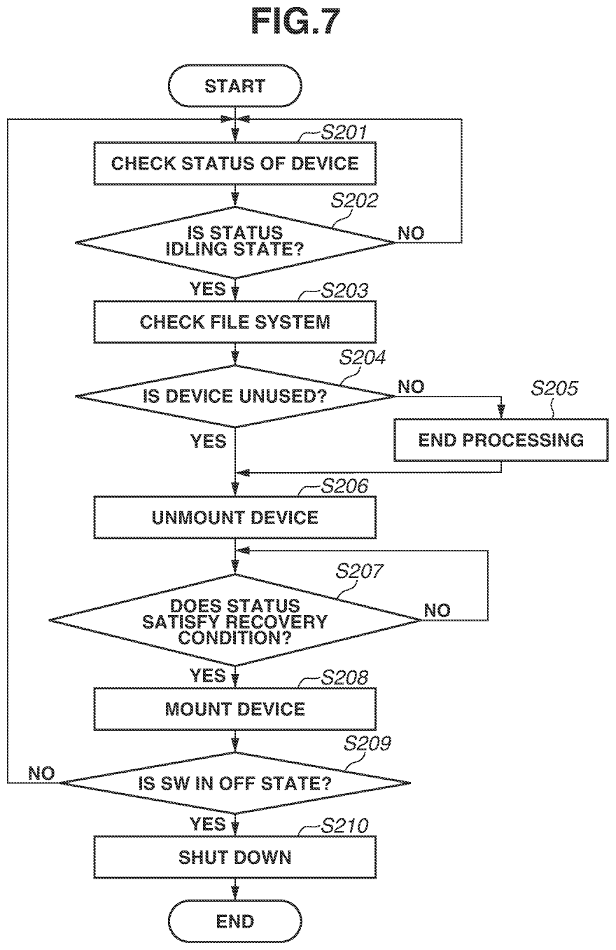

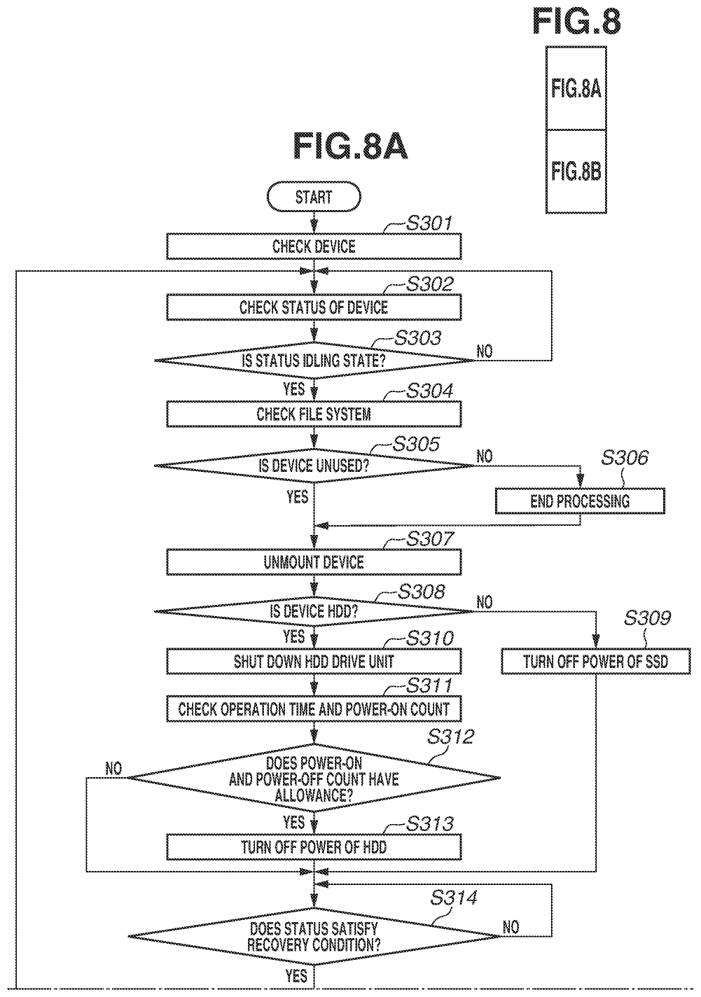

FIG. 6 is a diagram illustrating processing according to a second exemplary embodiment.

If the CPU 401 detects that the state of the image forming apparatus is in the idling state, the CPU 401 cancels a logical connection state (mount state) of the storage device 413. Thus, the storage device 413 is separated (unmounted) from the file system of the OS 10 so that access to the storage device 413 from the apps 21 can be blocked.

FIG. 7 is a flowchart illustrating an example of information processing according to the second exemplary embodiment. The processing illustrated in FIG. 7 is achieved by the CPU 401 to execute the processing based on the OS 10.

In step S201, the CPU 401 checks a status of the image forming apparatus.

In step S202, if the status checked in step S201 is the idling state where no job is input and no operation is performed by a user (Yes in step S202), the processing proceeds to step S203, and if not (No in step S202), the processing returns to step S201.

In step S203, the CPU 401 checks the file system of the OS 10, and in step S204, checks a use state of the storage device 413. If the storage device 413 is unused (Yes in step S204), the processing proceeds to step S206, and if not (No in step S204), the processing proceeds to step S205.

In step S205, the CPU 401 identifies processing which uses the device from the file system, and ends the identified processing so as to cancel the use state.

In step S206, the CPU 401 executes an unmount command on the OS 10, and cancels the mount state of the storage device 413. The processing in step S206 is an example of processing for canceling the logical connection state of the storage device 413 and blocking the access to the storage device 413.

In step S207, the CPU 401 determines whether the status satisfies a condition for recovery to the normal operation state, such as a job being input and an operation being performed by a user. If the CPU 401 determines that the status satisfies the recovery condition (Yes in step S207), the processing proceeds to step S208. If not (No in step S207), the CPU 401 repeats the processing in step S207.

In step S208, the CPU 401 executes the mount command on the OS 10, and mounts the storage device 413. The processing in step S208 is an example of processing for enabling the logical connection state.

In step S209, the CPU 401 checks the power switch of the image forming apparatus. If the CPU 401 determines that the switch is in the off state (Yes in step S209), the processing proceeds to step S210. If not (No in step S209), the processing returns to step S201.

In step S210, the CPU 401 executes shutdown processing.

According to the present exemplary embodiment, the HDD is logically separated by cancel processing of the logical connection state and thus unnecessary access from the apps 21 can be blocked without increasing the power-on count. Accordingly, the loading and unloading count can be suppressed.

In a third exemplary embodiment, the processing after unmount in the second exemplary embodiment is changed based on a type of the storage device 413. The CPU 401 turns off the power immediately in a case where the storage device 413 is the SSD. In the case of the HDD, the CPU 401 selects shutdown of the drive unit or shutdown of the power depending on the power-on count.

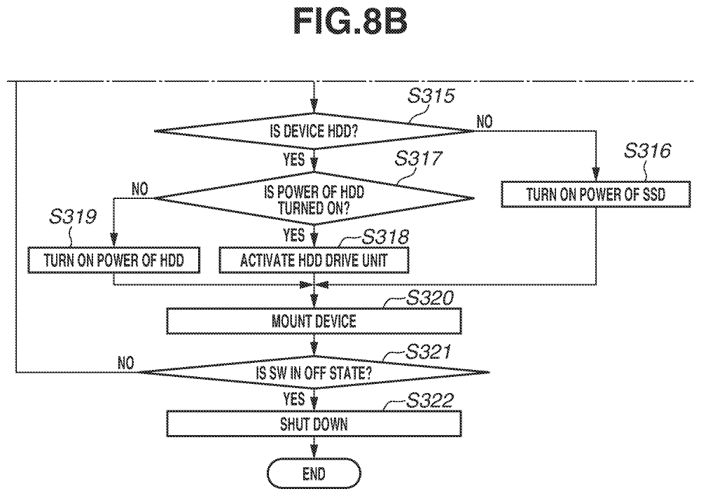

FIGS. 8A and 8B are flowcharts illustrating an example of information processing according to the third exemplary embodiment. The processing illustrated in FIGS. 8A and 8B is achieved by the CPU 401 executing the processing based on the OS 10.

In step S301, the CPU 401 acquires S.M.A.R.T. information (diagnostic information) about the storage device 413, and identifies a type of the storage device 413.

The processing in steps S302 to S307 is identical to the processing in steps S201 to S206 according to the second exemplary embodiment.

In step S308, if the CPU 401 determines that the storage device 413 is the HDD based on the diagnostic information (Yes in step S308), the processing proceeds to step S310. If not HDD (No in step S308), the processing proceeds to step S309. The processing in step S308 is an example of processing for determining whether the storage device 413 is the HDD or the SSD after the logical connection state of the storage device 413 is canceled.

In step S309, the CPU 401 turns off the power of the SSD via the storage control unit 412.

In step S310, the CPU 401 sends a spindle motor shutdown command to the HDD via the storage control unit 412. The HDD, which has received the shutdown command, causes the control unit 1001 to shut down the disk drive unit 1005.

In step S311, the CPU 401 checks a cumulative operation time of the image forming apparatus, and checks a power-on count based on the diagnostic information about the HDD.

In step S312, the CPU 401 compares a ratio of the cumulative operation time to a service life of the image forming apparatus with a ratio of the power-off and power-on count read from the diagnostic information to a limit value of the power-off and power-on count of the HDD. As a result of the comparison, if the ratio of the power-off and power-on count is smaller than the ratio of the cumulative operation time, the CPU 401 determines that the power-off and power-on count has an allowance (Yes in step S312), and the processing proceeds to step S313. As a result of the comparison, if the ratio of the power-off and power-on count is not smaller than the ratio of the cumulative operation time, the CPU 401 determines that the power-off and power-on count does not have an allowance (No in step S312), and the processing skips step S313 to proceed to step S314.

In step S313, the CPU 401 turns off the power of the HDD.

In step S314, the CPU 401 determines whether the status satisfies a condition for recovery to the normal operation state, such as a job being input and an operation being performed by a user. If the CPU 401 determines that the status satisfies the recovery condition (Yes in step S314), the processing proceeds to step S315. If not (No in step S314), the CPU 401 repeats the processing in step S314.

In step S315, the CPU 401 checks a type of the storage device 413. As a result of the check, if the storage device 413 is the HDD (Yes in step S315), the processing proceeds to S317. As a result of the check, if the storage device 413 is not the HDD (No in step S315), the processing proceeds to step S316.

In step S316, the CPU 401 turns on the power of the SSD.

In step S317, the CPU 401 determines whether the HDD is energized. If the HDD is energized (Yes in step S317), the processing proceeds to step S318. If not (No in step S317), the processing proceeds to step S319.

In step S318, the CPU 401 activates the spindle motor of the HDD.

In step S319, the CPU 401 turns on the power of the HDD.

The processing in steps S320 to S322 are identical to the processing in steps S208 to S210 according to the second exemplary embodiment.

In the processing according to the present exemplary embodiment, the power of the storage device 413 is turned off depending on the type of the storage device 413 and a state of the power-on count after the unmount processing, and thus power consumption can be suppressed.

Error processing to be executed when the access to the storage device 413 is blocked by the processing for shutting down the drive unit of the HDD and the processing for unmounting the storage device 413 described in the first to third exemplary embodiments will be described below as a fourth exemplary embodiment.

Even when the storage device 413 is in the access blocked state, the apps 21 periodically access the storage device 413. In this case, no access destination is present, and thus the apps 21 notify the OS 10 of erroneous access. Reception of the error by the OS 10 adversely affects other operations in some cases, and thus the erroneous access to the storage is masked during the shutdown of the access.

A method for masking erroneous access includes a method to be performed on the OS 10 and a method to be performed on the application platform 20.

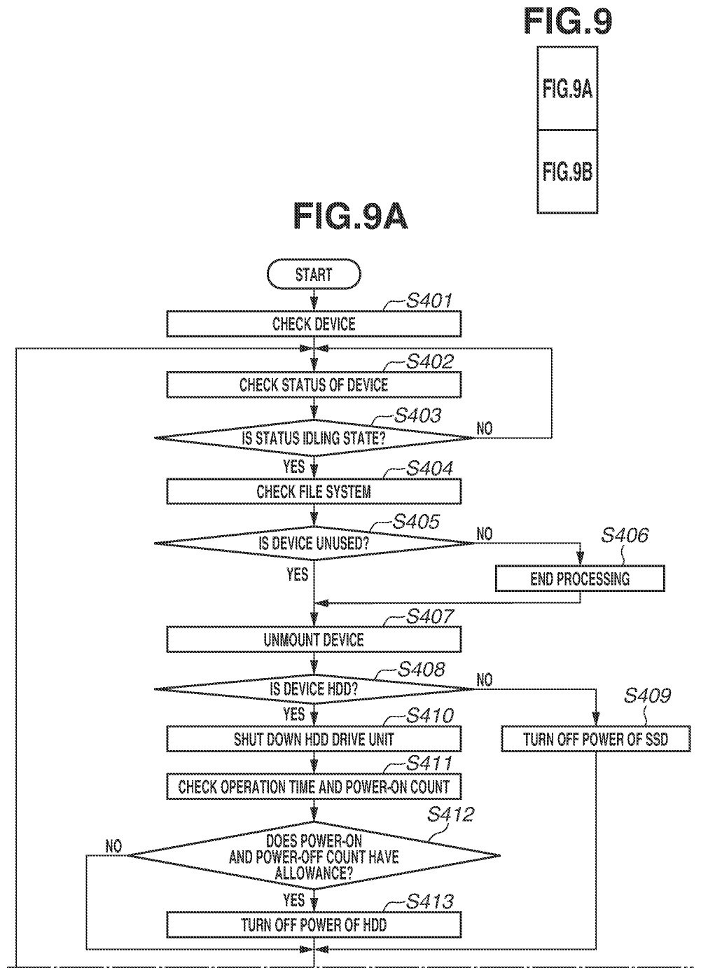

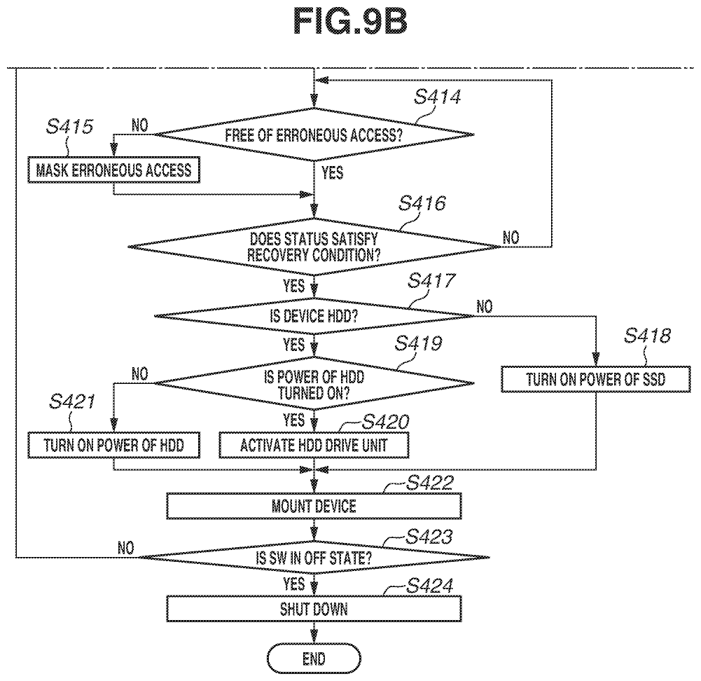

FIGS. 9A and 9B are flowcharts illustrating an example of the information processing in the third exemplary embodiment additionally including erroneous access mask processing on the OS 10. The erroneous access mask processing can be applied also to the first and second exemplary embodiments. The processing illustrated in FIGS. 9A and 9B is achieved by the CPU 401 executing the processing based on the OS 10.

The processing in steps S401 to S413 is identical to the processing in steps S301 to S313 according to the third exemplary embodiment.

In step S414, the CPU 401 checks erroneous access to the storage device 413. If erroneous access is made (No in step S414), the processing proceeds to step S415. If the storage device 413 is free of erroneous access (Yes in step S414), the processing proceeds to step S416.

In step S415, the CPU 401 masks the erroneous access.

In step S416, the CPU 401 determines whether the status satisfies a condition for recovery to the normal operation state, such as a job being input and an operation being performed by a user. If the CPU 401 determines that the status satisfies the recovery condition (Yes in step S416), the processing proceeds to step S417. If not (No in step 416), the CPU 401 repeats the processing in step S414.

The processing in steps S417 to S424 is identical to the processing in steps S315 to S322 according to the third exemplary embodiment.

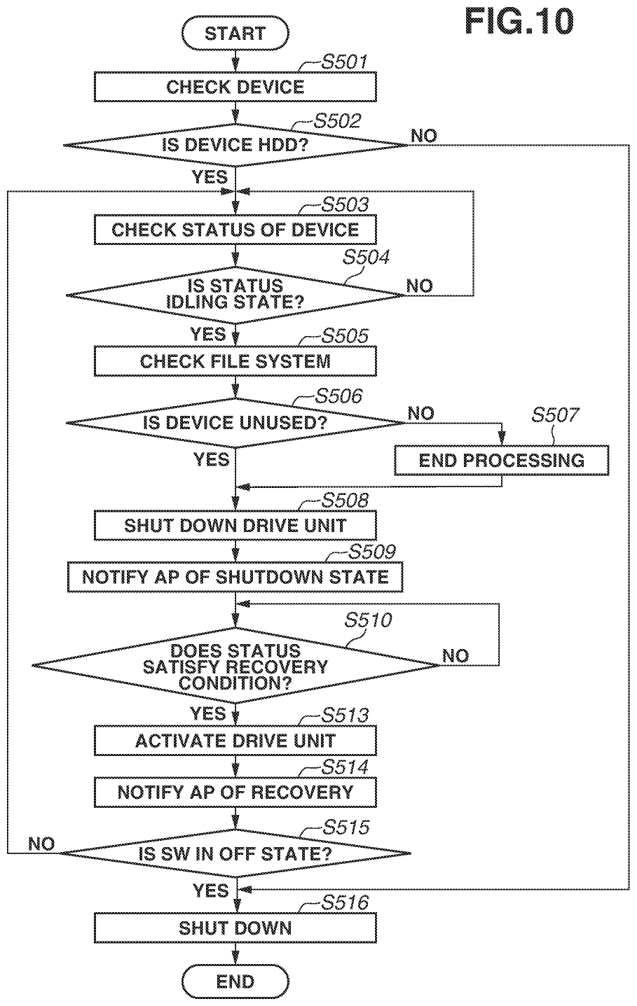

FIG. 10 is a flowchart illustrating an example of the information processing on the OS 10 in the first exemplary embodiment additionally including the erroneous access mask processing on the application platform 20. The processing illustrated in FIG. 10 is achieved by the CPU 401 executing the processing based on the OS 10.

The processing in steps S501 to S508 is identical to the processing in steps S101 to S108 according to the first exemplary embodiment.

In step S509, the CPU 401 notifies the application platform 20 of the shutdown state of the storage device 413.

The processing in steps S510 to S513 is identical to the processing in steps S109 to S110 according to the first exemplary embodiment.

In step S514, the CPU 401 notifies the application platform 20 that the storage device 413 has recovered to the normal state.

The processing in steps S515 to S516 is identical to the processing in steps S111 to S112 according to the first exemplary embodiment.

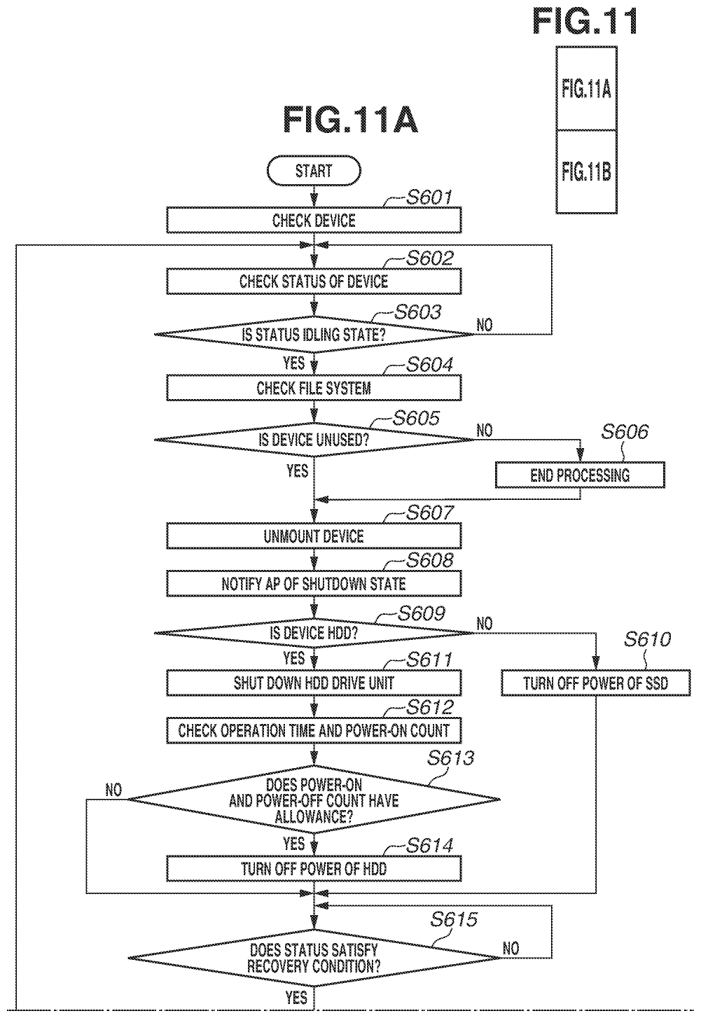

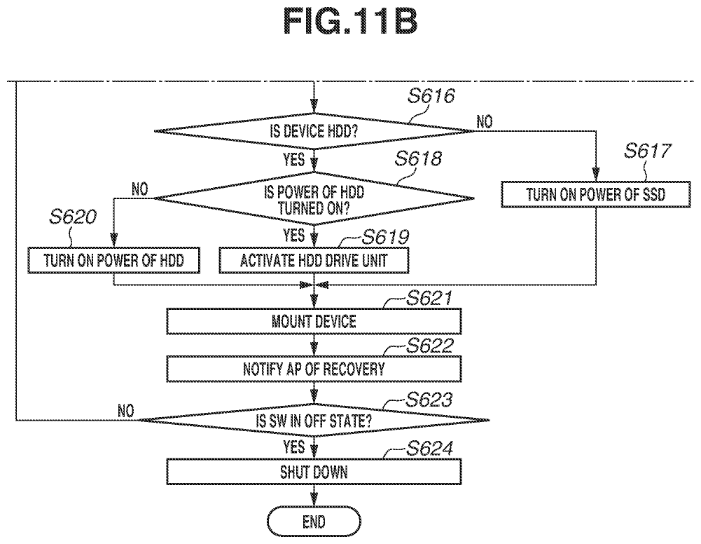

FIG. 11 is alternate embodiment of operations described in FIG. 8. The processing in steps S601 to S607 is identical to the processing in steps S301 to S307 according to the third exemplary embodiment.

In step S608, the CPU 401 notifies the application platform 20 that the storage device 413 is in the shutdown state.

The processing in steps S609 to S621 is identical to the processing in steps S308 to S320 according to the third exemplary embodiment.

In step S622, the CPU 401 notifies the application platform 20 that the storage device 413 has recovered to the normal state.

The processing in steps S623 to S624 is identical to the processing in steps S321 to S322 according to the third exemplary embodiment.

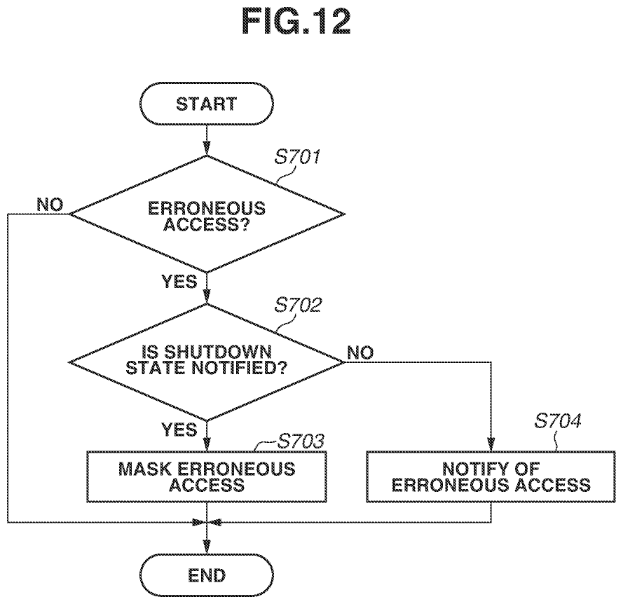

FIG. 12 is a flowchart illustrating an example of information processing on the application platform 20 additionally including erroneous access mask processing on the application platform 20. The processing illustrated in FIG. 12 is achieved by the CPU 401 executing processing based on the application platform 20.

In step S701, the CPU 401 determines whether erroneous access to the storage device 413 is received from the apps 21. If the CPU 401 receives the erroneous access to the storage device 413 from the apps 21 (Yes in step S701), the processing proceeds to step S702. If not (No in step S701), the processing of the flowchart in FIG. 12 ends.

In step S702, the CPU 401 checks whether the CPU 401 receives a notification of the shutdown state of the storage device 413 from the OS 10. If the CPU 401 receives the notification of the shutdown state of the storage device 413 from the OS 10 (Yes in step S702), the processing proceeds to step S703. If not (No in step S702), the processing proceeds to step S704.

In step S703, the CPU 401 does not notify the OS 10 of the erroneous access.

In step S704, the CPU 401 notifies the OS 10 of the erroneous access.

In the processing according to the present exemplary embodiment, the notification of the erroneous access to the storage device 413 from the application program is ignored when the access to the storage device 413 is blocked, thus avoiding a defective system operation caused by the erroneous access.

In the processing according to the present exemplary embodiment, the application program is notified that the storage device 413 is in the shutdown state when the access to the storage device 413 is blocked, and thus the access is shut down. Thus, occurrence of erroneous access can be inhibited.

According to the present embodiment, in a case where a degeneracy mode, which enables an operation even in a state where the apps 21 side does not have the storage device 413, is mounted, a shift to the degeneracy mode is performed when the storage device 413 is shut down. While the apps 21 are running in the degeneracy mode, the access to the storage device 413 is not performed. A fifth exemplary embodiment will now be described.

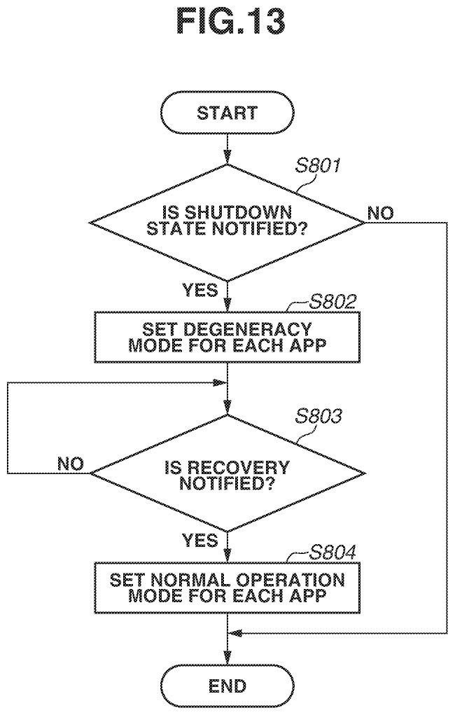

FIG. 13 is a flowchart illustrating an example of information processing according to the fifth exemplary embodiment. Processing illustrated in FIG. 13 is achieved by the CPU 401 by executing the processing based on the application platform 20.

In step S801, the CPU 401 determines whether the CPU 401 has received a notification of the shutdown state of the storage device 413 from the OS 10. If the CPU 401 has received the notification of the shutdown state of the storage device 413 from the OS 10 (Yes in step S801), the processing proceeds to step S802. If the CPU 401 has not received the notification of the shutdown state of the storage device 413 from the OS 10 (No in step S801), the processing of the flowchart illustrated in FIG. 13 ends.

In step S802, the CPU 401 executes a command for shifting to the degeneracy mode for the apps 21.

In step S803, the CPU 401 checks a notification of recovery of the storage device 413 from the OS 10. If the CPU 401 checks the notification of recovery of the storage device 413 (Yes in step S803), the processing proceeds to step S804. If the CPU 401 does not check the notification of the recovery of the storage device 413 (No in step S803), the CPU 401 repeats the processing in step S803.

In step S804, the CPU 401 executes a command for shifting to the normal operation mode for the apps 21.

In the present exemplary embodiment, parameters relating to a service life in S.M.A.R.T. information (diagnostic information) about the storage device 413 are monitored, and if any parameter reaches a predetermined threshold, the power of the storage device 413 is turned off so that the storage device 413 is protected, and a replacement instruction is shown on a display unit. Such processing will be described as a sixth exemplary embodiment.

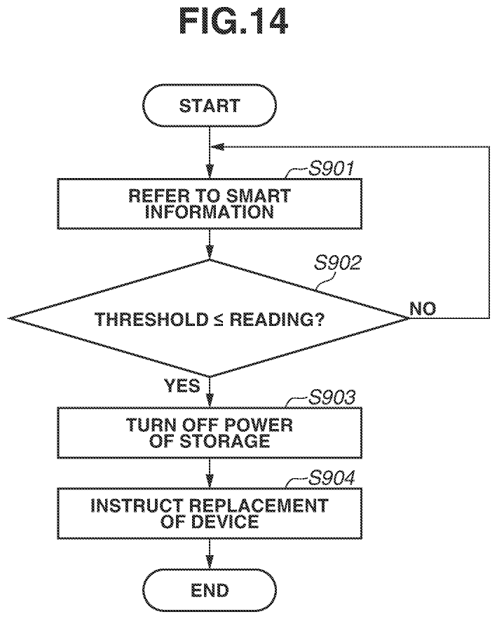

FIG. 14 is a flowchart illustrating an example of information processing according to the sixth exemplary embodiment. The processing illustrated in FIG. 14 is achieved by the CPU 401 executing the processing based on the OS 10.

In step S901, the CPU 401 checks parameter values relating to the service life based on the diagnostic information about the storage device 413.

In step S902, the CPU 401 checks whether any of the checked parameter readings relating to the service life reaches a preset threshold. If any of the checked parameter readings relating to the service life has reached the preset threshold (Yes in step S902), the processing proceeds to step S903. If not (No in step S902), the processing returns to step S901.

In S903, the CPU 401 turns off the power of the storage device 413.

In step S904, the CPU 401 displays an instruction for replacing the storage device 413 on the operation unit. The operation unit is an example of the display unit.

Herein, the parameters relating to the service life are as follows.

In the case where the storage device 413 is the HDD, the parameters include

Power-on count,

Energizing time period,

Total time period during which the magnetic head is on the disk,

Loading/unloading count, and

Operation time of the spindle motor.

In the case where the storage device 413 is the SSD, the parameters include

Average deletion count, and

Media wearout indicator.

In the processing according to the present exemplary embodiment, the CPU 401 determines that a failure might occur based on the diagnostic information about the storage device 413, and turns off the power of the storage device 413. In such a manner, the data saved in the storage device 413 can be protected.

According to the above-described exemplary embodiments, access restriction for avoiding a storage failure can be imposed while maintaining the limitation on the power-on count.

A plurality of application programs is installed for achieving high functionality of the image forming apparatus and for optimizing usage environment for a user.

However, some application programs, which are installed, frequently carry out periodic access to the storage device 413 which leads to an excess of the prescribed loading and unloading count, and results in storage damage. The present exemplary embodiment solves such an issue.

Even when the access count is attempted to be limited on the application program, such an attempt cannot be satisfied in some cases from a viewpoint of the entire system because many unidentified application programs exist and a plurality of applications is often installed into one image forming apparatus. The present exemplary embodiment reduces such a case.

The method for physically blocking the access to the storage includes a method for shutting down power supply to the storage, but the power-on count of the HDD is prescribed for a service life. Accordingly, this kind of control cannot be made only for the purpose of access restriction because the control for turning on the power after turning-off is also made in a power-saving mode of the image forming apparatus. Such an issue can be eliminated by the exemplary embodiments.

Further, the present exemplary embodiment can reduce frequent and periodic writing access to the SSD.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-173838, filed Sep. 18, 2018, which is hereby incorporated by reference herein in its entirety.

What is claimed is:

1. An image processing apparatus comprising:
a storage device; and
a control unit that, in a case where the storage device is a hard disk drive and the image processing apparatus is in an idling state, cancels a logical connection state of the storage device and blocks access to the storage device.

2. The image processing apparatus according to claim 1, wherein the access to the storage device is blocked by shutting down a drive unit of the storage device in a case where the image processing apparatus is in the idling state.

3. The image processing apparatus according to claim 2, wherein the control unit activates the drive unit in a case where a condition for recovery to a normal operation state is satisfied.

4. The image processing apparatus according to claim 1, wherein the control unit enables the logical connection state in a case where a condition for recovery to a normal operation state is satisfied.

5. The image processing apparatus according to claim 3, further comprising a determination unit configured to determine whether the storage device is a hard disk drive, or rather a solid state disk, after the control unit cancels the logical connection state of the storage device.

6. The image processing apparatus according to claim 5, wherein the control unit turns off power of the storage device in a case where the determination unit determines that the storage device is the solid state disk.

7. The image processing apparatus according to claim 5, wherein the control unit shuts down the drive unit of the storage device in a case where the determination unit determines that the storage device is the hard disk drive.

8. The image processing apparatus according to claim 7, wherein the control unit further compares a first ratio of a cumulative operation time of the image processing apparatus to a service life of the image processing apparatus with a second ratio of power-off and power-on of the storage device to a limit value of power-off and power-on of the storage device, and in a case where the second ratio is smaller than the first ratio, power of the storage device is turned off.

9. The image processing apparatus according to claim 1, wherein the control unit disables an error output from an application that has accessed to the storage device in a case where access to the storage device is blocked.

10. The image processing apparatus according to claim 1, wherein the control unit notifies an application that the storage device is unusable when access to the storage device is blocked.

11. The image processing apparatus according to claim 1, wherein, in a case where a parameter relating to a service life of the storage device reaches a set threshold, the control unit turns off power of the storage device and displays an instruction for replacing the storage device on a display unit.

12. The image processing apparatus according to claim 11, wherein the parameter is any of a power-on count, an energizing time period, a total time period during which a magnetic head is on a disk, a loading and unloading count, and an operation time of a spindle motor in a case where the storage device is a hard disk drive.

13. The image processing apparatus according to claim 11, wherein the parameter is an average deletion count or a media wearout indicator in a case where the storage device is a solid state disk.

14. The image processing apparatus according to claim 1, wherein the logical connection state of the storage device is canceled and the access to the storage device is blocked according to an unmount command of an operating system.

15. An information processing method to be executed by an image processing apparatus including a storage device, the method comprising canceling, in a case where the storage device is a hard disk drive and the image processing apparatus is in an idling state, a logical connection state of the storage device and blocking access to the storage device.
